(19) United States
(12) Patent Application Publication
(10) Pub. No.: US 2021/0063849 A1
(43) Pub. Date: Mar. 4, 2021

(54) MOUNT ADAPTER AND SHOOTING SYSTEM

(71) Applicant: SZ DJI TECHNOLOGY CO., LTD., Shenzhen (CN)

(72) Inventor: Futoshi IINUMA, Shenzhen (CN)

(21) Appl. No.: 16/950,394

(22) Filed: Nov. 17, 2020

Related U.S. Application Data
(63) Continuation of application No. PCT/CN2019/087618, filed on May 20, 2019.

(30) Foreign Application Priority Data
May 21, 2018 (JP) 2018-097456

(51) Int. Cl. G03B 17/56; H04N 5/225; H04N 5/232

(52) U.S. Cl. CPC G03B 17/56; G03B 17/561; H04N 5/23209; H04N 5/23299; H04N 5/2253; H04N 5/2254

(57) ABSTRACT

A mount adaptor includes a base member, a first connection member arranged at a first surface of the base member and configured to be detachably connected to a lens unit, a second connection member arranged at a second surface of the base member and configured to be detachably connected to a shooting device, and an operation member configured to be operated to mount the second connection member to or detach the second connection member from the shooting device. The second connection member includes an adapter-side engagement member configured to move in conjunction with the operation member with respect to the base member, to engage with a mount-side engagement member of a lens mount.

### CROSS-REFERENCE TO RELATED APPLICATIONS

This application is a continuation of International Application No. PCT/CN2019/087618, filed on May 20, 2019, which claims priority to Japanese Application No. 2018-097456, filed on May 21, 2018, the entire contents of both of which are incorporated herein by reference.

### TECHNICAL FIELD

The present disclosure relates to a mount adapter and a shooting system.

### BACKGROUND

Patent Document 1 discloses a mechanism rotatably supporting a shooting device by fixedly mounting the shooting device holding a lens unit to a mounting member and detachably mounting the mounting member to a gimbal.

Patent Document 1: Japanese Patent Application Publication No. H9-18776.

A conventional mount adapter is interposed between the lens unit and the shooting device and is mounted to rotate with respect to the shooting device. Sometimes the mount adapter cannot be rotated with respect to the shooting device due to a physical constraint.

### SUMMARY

In accordance with the disclosure, there is provided a mount adaptor including a base member, a first connection member arranged at a first surface of the base member and configured to be detachably connected to a lens unit, a second connection member arranged at a second surface of the base member and configured to be detachably connected to a shooting device, and an operation member configured to be operated to mount the second connection member to or detach the second connection member from the shooting device. The second connection member includes an adapter-side engagement member configured to move in conjunction with the operation member with respect to the base member, to engage with a mount-side engagement member of a lens mount.

Also in accordance with the disclosure, there is provided a shooting system including a shooting device including an image sensor; a support mechanism configured to rotatably support the shooting device; and a mount adaptor. The mount adaptor includes a base member, a first connection member arranged at a first surface of the base member and configured to be detachably connected to a lens unit, a second connection member arranged at a second surface of the base member and configured to be detachably connected to a shooting device, and an operation member configured to be operated to mount the second connection member to or detach the second connection member from the shooting device. The second connection member includes an adapter-side engagement member configured to move in conjunction with the operation member with respect to the base member, to engage with a mount-side engagement member of a lens mount.

### BRIEF DESCRIPTION OF THE DRAWINGS

FIG. 1 is a schematic perspective view of a shooting system consistent with embodiments of the disclosure.

FIG. 2 is a schematic side view of a shooting system consistent with embodiments of the disclosure.

FIG. 3 is a schematic perspective view of a shooting system with a mount adapter mounted to a shooting device consistent with embodiments of the disclosure.

FIG. 4 is a schematic side view of a shooting system with a mount adapter mounted to a shooting device consistent with embodiments of the disclosure.

FIG. 5 is a schematic perspective view of a shooting system with a support mounted to a main body consistent with embodiments of the disclosure.

FIG. 6 is a schematic side view of a shooting system with a support mounted to a main body consistent with embodiments of the disclosure.

FIG. 7 is a schematic perspective view of a mount adapter, a shooting device, and a gimbal viewed from a front side in a state where the mount adapter is detached from the shooting device consistent with embodiments of the disclosure.

FIG. 8 is a schematic perspective view of a mount adapter, a shooting device, and a gimbal viewed from a rear side in a state where the mount adapter is detached from the shooting device consistent with embodiments of the disclosure.

FIG. 9A is a schematic diagram of a mount adapter and a shooting device in an unlocked state consistent with embodiments of the disclosure.

FIG. 9B is a schematic diagram of a mount adapter and a shooting device in a locked state consistent with embodiments of the disclosure.

FIG. 10 is a schematic perspective view of a mount adapter with some components being removed consistent with embodiments of the disclosure.

FIG. 11 is an enlarged perspective view of a lock mechanism consistent with embodiments of the disclosure.

FIG. 12 is another enlarged perspective view of a lock mechanism consistent with embodiments of the disclosure.

FIG. 13 is a schematic diagram showing a state where a mount adapter is fixed to a main body via a support when a shooting device is in a horizontal shooting attitude consistent with embodiments of the disclosure.

FIG. 14 is a schematic diagram showing a state where a mount adapter is fixed to a main body via a support when a shooting device is in a vertical shooting consistent with embodiments of the disclosure.

FIG. 15 is a schematic block diagram of a shooting system consistent with embodiments of the disclosure.

### DETAILED DESCRIPTION OF THE EMBODIMENTS

Hereinafter, example embodiments will be described to illustrate the present disclosure, but the disclosed embodiments are not intended to limit the scope of the claims. Not all of the combinations of features described in the embodiments are necessary for a solution of the present disclosure. Changes, modifications, alterations, and variations of the above-described embodiments may be made by those skilled in the art and should fall within the scope of the present disclosure.

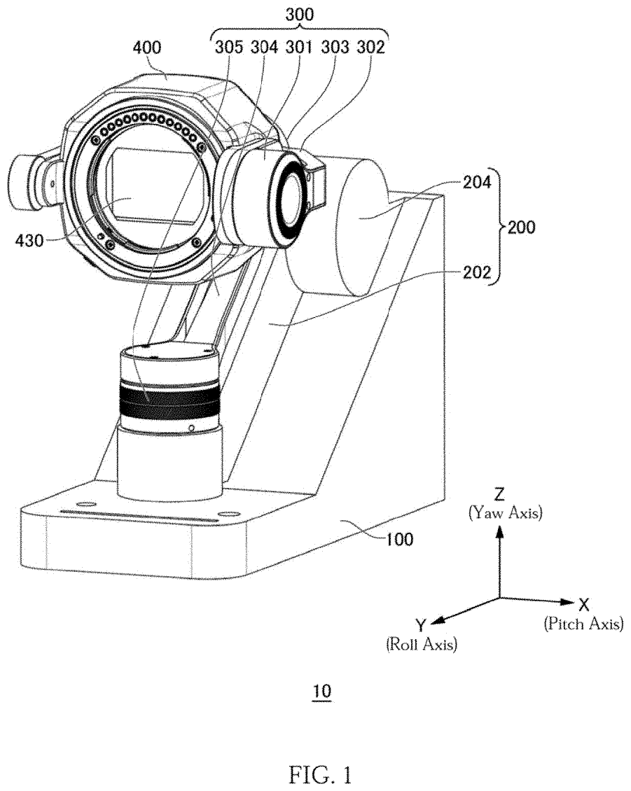

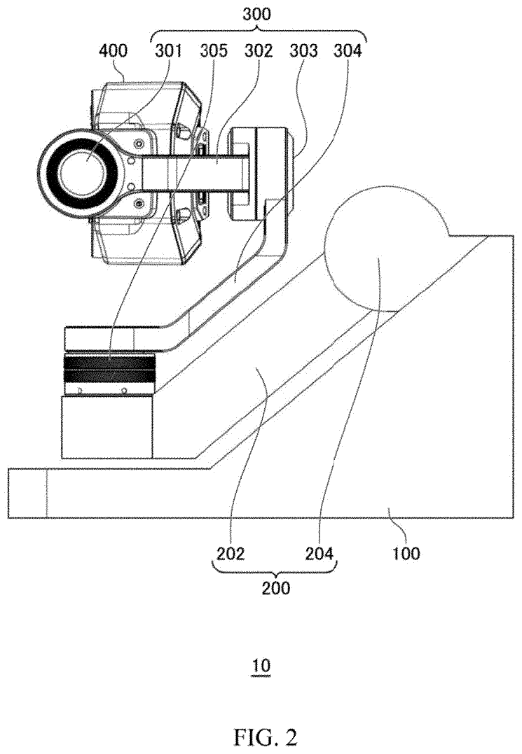

FIG. 1 is a schematic perspective view of an example shooting system 10 consistent with the disclosure. FIG. 2 is a schematic side view of the shooting system 10.

As shown in FIGS. 1 and 2, the shooting system 10 includes a main body 100, a holding mechanism 200, a gimbal 300, and a shooting device 400. The shooting device 400 includes an image sensor 430 inside the shooting device 400. The shooting device 400 can detachably hold a lens unit. The holding mechanism 200 can movably hold the gimbal 300 along a Z axis (e.g., a yaw axis) direction with respect to the main body 100. The holding mechanism 200 includes a holding member 202 and a rotation member 204. The holding member 202 is fixed to the main body 100 via the rotation member 204. The holding member 202 can hold the gimbal 300. The rotation member 204 can be rotatably connected to one end of the holding member 202, and the gimbal 300 can be connected, rotatably around the yaw axis, to another end of the holding member 202. The rotation member 204 can include an actuator including a rotor, and can be driven by the actuator to rotate.

The gimbal 300 is an example of a support mechanism rotatably supporting the shooting device 400. The shooting device 400 may include a housing accommodating the image sensor 430, and the gimbal 300 may rotatably support the housing. The gimbal 300 can support the shooting device 400 to rotate around an X axis (e.g., a pitch axis) by using the actuator. The gimbal 300 may support the shooting device 400 to further rotate around a Y axis (e.g., a roll axis) and the Z axis (e.g., the yaw axis) by using the actuator. The gimbal 300 may rotate the shooting device 400 about at least one of the yaw axis, the pitch axis, and the roll axis to change an attitude of the image sensor 430.

The gimbal 300 includes a rotation member 301, a rotation member 303, a rotation member 305, a support member 302 and a support member 304. Each of the rotation member 301, the rotation member 303, and the rotation member 305 can include an actuator including a rotor. The rotation member 301 is arranged at one end of the support member 302. The rotation member 303 is arranged at another end of the support member 302. Another end of the support member 302 is connected to one end of the support member 304 via the rotation member 303. The rotation member 305 is arranged at another end of the support member 304. Another end of the support member 304 is connected to another end of the holding member 202 via the rotation member 305. The support member 302 can support the shooting device 400 in such a manner that the shooting device 400 can rotate around the pitch axis via the rotation member 301. The support member 302 is an example of a first support member, which can support the shooting device 400 in such a manner that the shooting device 400 can rotate around the pitch direction via the rotation member 303. The support member 304 can support the support member 302 in such a manner that the shooting device 400 can rotate about the roll axis via the rotation member 303. The support member 304 is an example of a second support member, which can support the support member 302 in such a manner that the shooting device 400 can rotate along a vertical pivoting direction. The support member 304 can be supported by the holding member 202 in such a manner that the shooting device 400 can be rotated along a horizontal pivoting direction via the rotation member 305.

The shooting device 400 can detachably hold a lens unit including at least one lens. The lens unit may include an interchangeable lens.

Various types of lens units can be detachably mounted to the shooting device 400 in the shooting system 10. However, there are also lens units that do not meet a standard of the shooting device 400. In order to enable the shooting device 400 to hold the lens units not meeting the standard, the shooting system 10 may further include a mount adapter connecting the shooting device 400 and the lens unit.

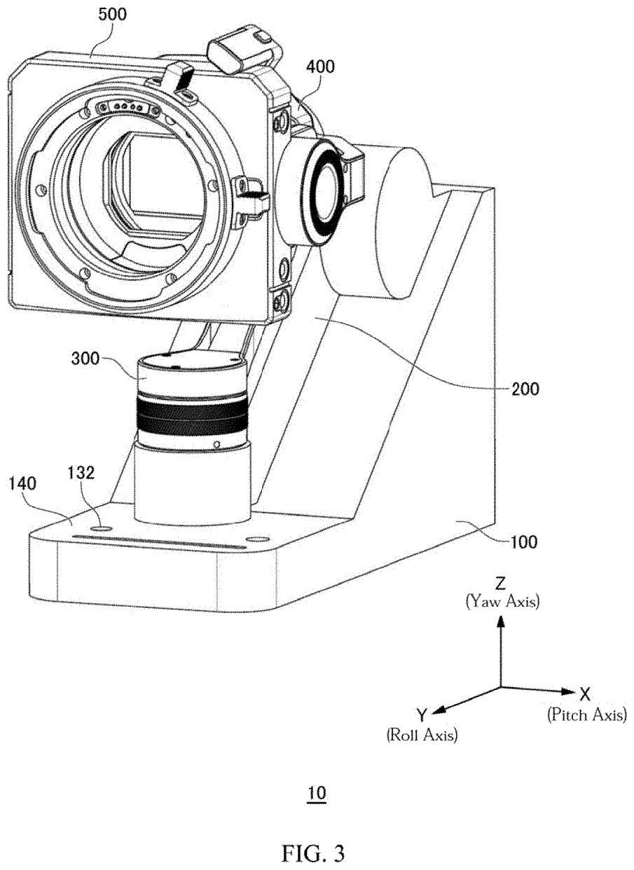

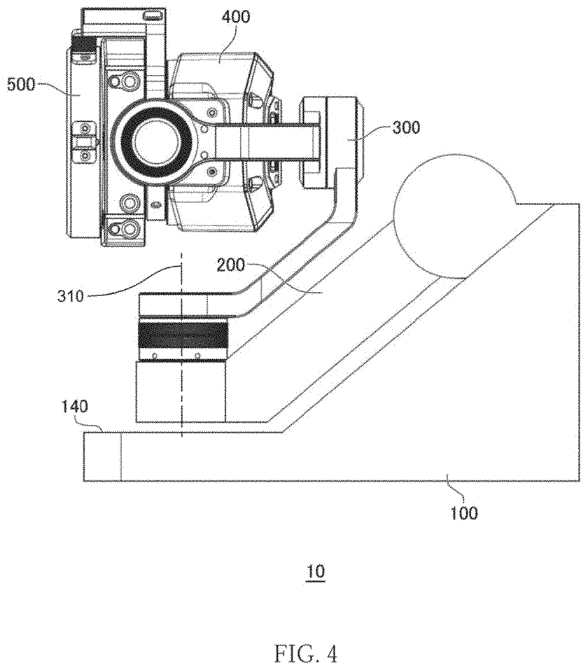

FIG. 3 is a schematic perspective view of the shooting system 10 with a mount adapter 500 mounted to the shooting device 400 consistent with the disclosure. FIG. 4 is a schematic side view of the shooting system 10 with the mount adapter 500 mounted to the shooting device 400 consistent with the disclosure. As shown in FIGS. 3 and 4, the mount adapter 500 can include a mount structure complying with the standard of the shooting device 400 (e.g., a standard of the lens unit that can be mounted to the shooting device 400). Various types of lens units can be mounted to the shooting device 400 using the mount adapter 500. The mount adaptor 500 can be detachably connected to the lens unit not meeting the standard of the mount structure of the shooting device 400. The mount adaptor 500 can also be detachably connected to the lens unit meeting the standard of the mount structure of the shooting device 400.

However, there are also lens units that are difficult to be stably supported by the gimbal 300 due to their large weights, long lengths, or the like. For example, there are also lens units with which it is difficult to maintain a position of the shooting device 400 with respect to the main body 100. Thus, the shooting system 10 may further include a support that can support the shooting device 400 to maintain the position of the shooting device 400 with respect to the main body 100.

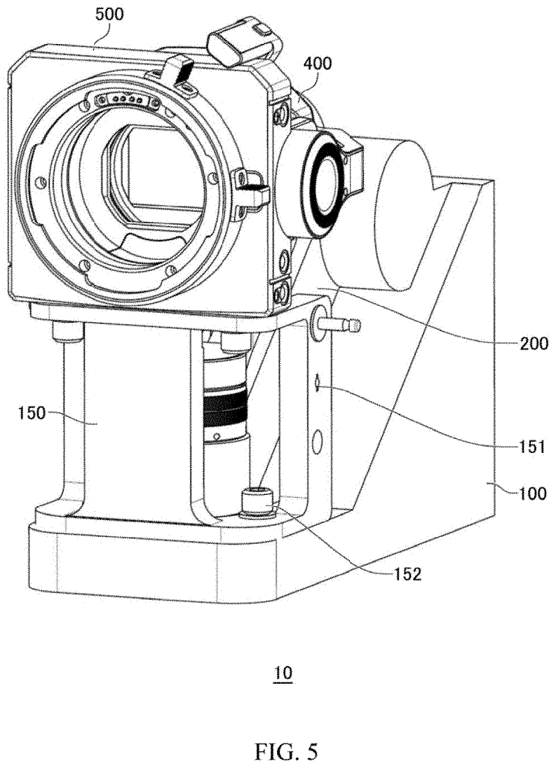

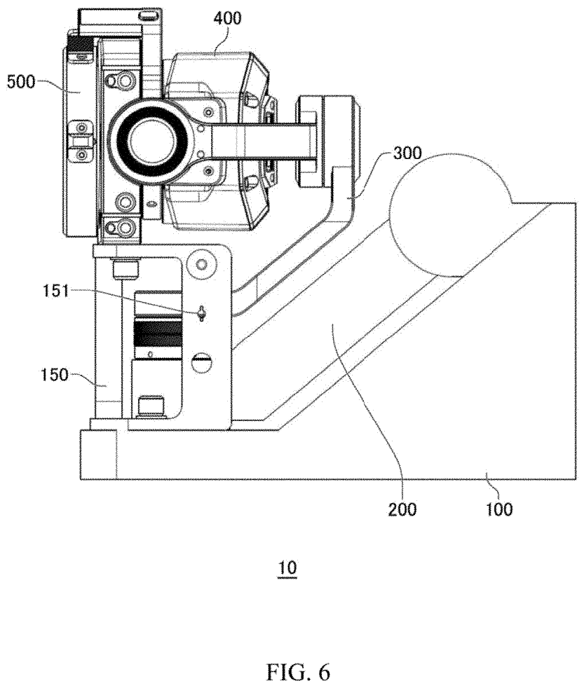

FIG. 5 is a schematic perspective view of the shooting system 10 with a support 150 mounted to the main body 100 consistent with the disclosure. FIG. 6 is a schematic side view of the shooting system 10 with the support 150 mounted to the main body 100 consistent with the disclosure.

As shown in FIGS. 5 and 6, the support 150 can support the shooting device 400 to maintain the position of the shooting device 400 with respect to the main body 100. The support 150 may be fixedly mounted to the main body 100 and the shooting device 400. The support 150 may be fixedly mounted to the main body 100 via a bolt 152. The support 150 can include a through hole larger than an outer diameter of the bolt 152. The bolt 152 can be screwed to the main body 100 via the through hole. The support 150 includes a mark 151 indicating a position of an imaging surface of the image sensor 430 on an outer surface. The support 150 may include the mark 151 on a side of the support 150. In some embodiments, when the shooting device 400 is supported by the support 150, the gimbal 300 does not control the attitude of the shooting device 400. That is, the gimbal 300 does not work when the shooting device 400 is supported by the support 150.

Referring again to FIGS. 3 and 4, the main body 100 includes a fixing surface 140 for fixing the support 150. The fixing surface 140 is located below the shooting device 400 and the mount adapter 500. The main body 100 may include a detection sensor 132 on the fixing surface 140 for detecting if the support 150 is mounted to the main body 100. The detection sensor 132 may include a mechanical switch that can be turned on in response to the support 150 being mounted to the fixing surface 140. The detection sensor 132 may include an electrical element that can be electrically conductive in response to the support 150 being mounted to the fixing surface 140.

The gimbal 300 can stably support various lens units by supporting the shooting device 400 through the support 150. In some embodiments, the support 150 may not be fixedly mounted to the mount adapter 500 but to the shooting device 400. In some other embodiments, the support 150 may also be fixedly mounted to the mount adapter 500 and the shooting device 400.

The holding mechanism 200 can hold the gimbal 300 in such a way that the shooting device 400 can move closer to or away from the fixing surface 140. The holding mechanism 200 includes the rotation member 204 that can rotate the holding member 202 holding the gimbal 300 with respect to the main body 100 around an axis (e.g., the pitch axis) of the fixing surface 140. Therefore, the holding mechanism 200 can adjust a height of the shooting device 400 from the fixing surface 140. Therefore, it is possible to prevent the support 150 from being unable to be fixed to the mount adapter 500 or the shooting device 400 due to the position offset of the shooting device 400 with respect to the main body 100 in the Z direction.

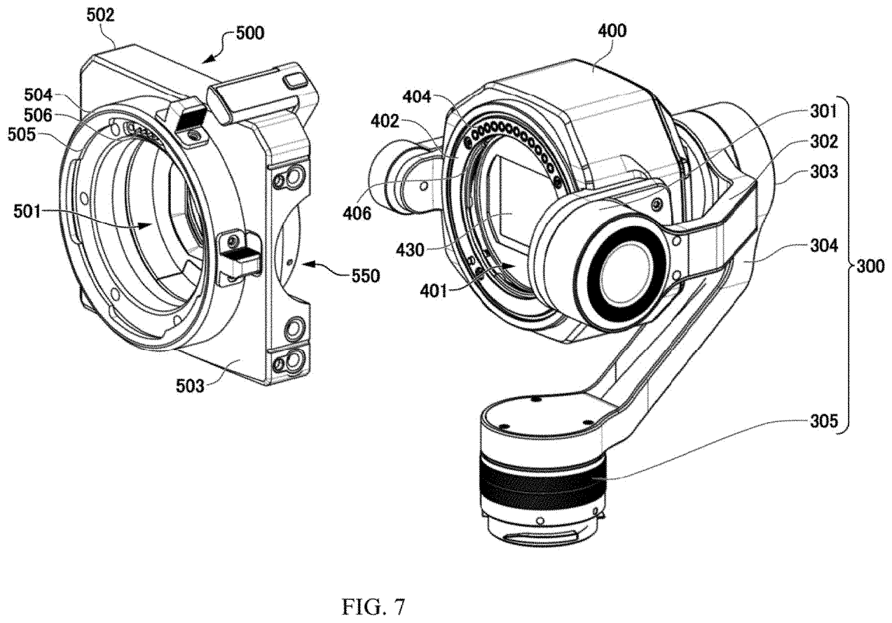

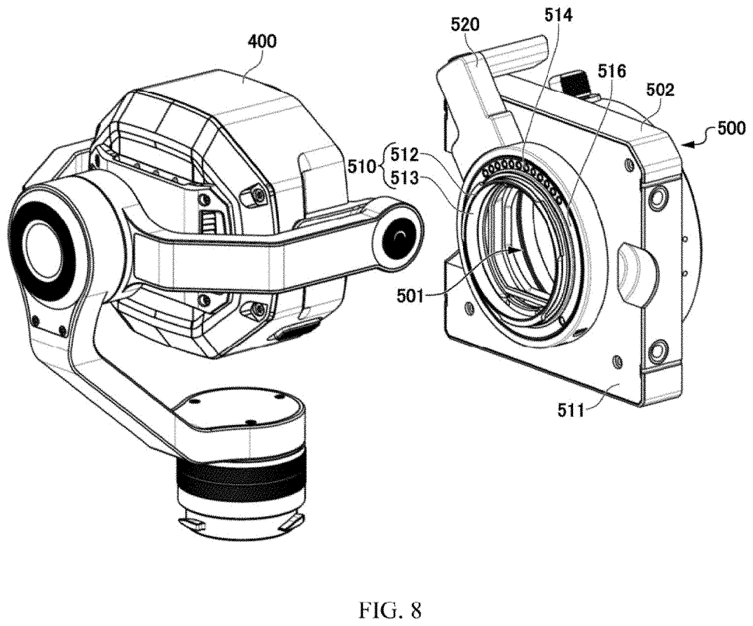

FIG. 7 is a schematic perspective view of the mount adapter 500, the shooting device 400, and the gimbal 300 viewed from a front side in a state where the mount adapter 500 is detached from the shooting device 400 consistent with the disclosure. FIG. 8 is a schematic perspective view of the mount adapter 500, the shooting device 400, and the gimbal 300 viewed from a rear side in the state where the mount adapter 500 is detached from the shooting device 400 consistent with the disclosure.

As shown in FIGS. 7 and 8, the shooting device 400 includes an opening 401 through which the image sensor 430 can be exposed. The opening 401 may have a circular shape. The shooting device 400 includes a lens mount 402 around the opening 401. The lens mount 402 may include a bayonet type lens mount. The lens mount 402 includes a mount-side engagement member 406. The mount-side engagement member 406 can refer to an engagement member arranged at the lens mount 402. The mount-side engagement member 406 protrudes toward an inside of the opening 401. The mount-side engagement member 406 may include a flange protruding toward the inside of the opening 401. The lens mount 402 includes a contact 404 along an edge of the opening 401.

The mount adapter 500 includes a base member 502. The base member 502 may have a rectangular plate shape. The base member 502 includes an opening 501 at a position opposite to the opening 401. The mount adapter 500 includes a connection member 504 arranged at a first surface 503 of the base member 502 and configured to be detachably connected to the lens unit. The connection member 504 is an example of a first connection member. The connection member 504 may include a bayonet type mount structure. The connection member 504 includes a contact 506 electrically connected to the contact 404 of the lens unit around the opening 501. The connection member 504 includes an adaptor-side engagement member 505 protruding toward an inside of the opening 501. The adaptor-side engagement member 505 can refer to an engagement member arranged at the mount adapter 500. The adaptor-side engagement member 505 is an example of a second adaptor-side engagement member. The adaptor-side engagement member 505 may include a flange protruding toward the inside of the opening 501. In some embodiments, the connection member 504 may include a plurality of adaptor-side engagement members 505. For example, the connection member 504 may include three adaptor-side engagement members 505 along the edge of the opening 501. When the lens unit rotates with respect to the mount adapter 500, the adaptor-side engagement member 505 can engage with a lens-side engagement member included in the lens unit, and thus, the lens unit can be connected to the mount adapter 500. The lens-side engagement member can refer to an engagement member arranged at the lens unit. Herein, the engagement between the adaptor-side engagement member 505 and the lens-side engagement member can refer to that at least a portion of the lens-side engagement member is located at and overlaps with a back side of at least a portion of the adaptor-side engagement member 505, and a movement of the lens unit with respect to the mount adapter 500 in an optical axis direction is limited. For example, at least a portion of the lens-side engagement member overlaps with at least a portion of the adaptor-side engagement member 505 in the optical axis direction, but at least a portion of the lens-side engagement member is not in contact with at least a portion of the adaptor-side engagement member 505.

The base member 502 includes a connection member 510 arranged at a second surface 511 opposite to the first surface 503 and configured to be detachably connected to the shooting device 400. The connection member 510 is an example of a second connection member. The connection member 510 includes an adaptor-side engagement member 512 engaging with the mount-side engagement member 406 of the shooting device 400. The adapter-side engagement member 512 is an example of a first adapter-side engagement member. The connection member 510 may include a plurality of adapter-side engagement members 512. The adapter-side engagement member 512 protrudes toward an outside of the opening 501. The adapter-side engagement member 512 may include a flange protruding toward the outside of the opening 501. The adapter-side engagement member 512 can be engaged with the mount-side engagement member 406 of the shooting device 400, and thus, the mount adapter 500 and the shooting device 400 can be connected. Herein, the engagement between the adapter-side engagement member 512 and the mount-side engagement member 406 can refer to that at least a portion of the adapter-side engagement member 512 is located at and overlaps with a back side of at least a portion of the mount-side engagement member 406 of the shooting device 400, and a movement of the shooting device 400 with respect to the mount adapter 500 in an optical axis direction is limited. For example, at least a portion of the adapter-side engagement member 512 overlaps with at least a portion of the mount-side engagement member 406 of the shooting device 400 in the optical axis direction, but at least a portion of the adapter-side engagement member 512 is not in contact with at least a portion of the mount-side engagement member 406 of the shooting device 400.

The base member 502 further includes a contact 514 electrically connected to the contact 404 of the shooting device 400 on the second surface 511. The base member 502 may include a plurality of contacts 514 along the opening 501.

The shooting device 400 can be rotatably connected to the rotation member 301 arranged at one end of the support member 302 of the gimbal 300. The rotation member 301 can include an actuator and protrude from a mount surface of the lens mount 402. The base member 502 includes a concave portion 550 corresponding to the rotation member 301 on a side of the base member 502. When the mount adapter 500 is mounted to the shooting device 400, the rotation member 301 can fit into the concave portion 550.

The rotation member 301 protruding from the mount surface of the lens mount 402 can become a barrier, and the adapter-side engagement member 512 cannot be engaged with the mount-side engagement member 406 to mount the shooting device 400 by rotating the mount adapter 500 with respect to the shooting device 400. Therefore, the connection member 510 further includes a rotation body 513. The rotation body 513 can have an annular shape. The rotation body 513 can be arranged, rotatably with respect to the base portion 502, at the opening 501 of the base member 502.

The mount adapter 500 further includes a holding member 516 holding the contact 514 and holding the rotation body 513 rotatably with respect to the base member 502. The holding member 516 can be fixed to the second surface 511 of the base member 502. The holding member 516 can include a first through hole through which the contact 514 can be exposed. The holding member 516 includes a second through hole through which a portion of the rotation body 513 can penetrate. The holding member 516 can rotatably cover portions other than the portion of the rotation body 513 protruding from the holding member 516 with respect to the base portion 502.

The adapter-side engagement member 512 can be arranged to protrude outward from an outer peripheral surface of the portion of the rotation body 513 protruding from the holding member 516. The mount adapter 500 further includes an operation member 520 configured to rotate the rotation body 513 with the adapter-side engagement member 512 with respect to the base member 502. The operation member 520 can be operated when the connection member 510 is detached from the shooting device 400.

The rotation body 513 can be connected to the operation member 520 and the adapter-side engagement member 512, such that the rotation body 513 can move in conjunction with the operation member 520 with respect to the base member 502, and thus, can rotate with respect to the base member 502 together with the adapter-side engagement member 512. The rotation body 513 can be integrated with the adapter-side engagement member 512. The adapter-side engagement member 512 can move in conjunction with the operation member 520 with respect to the base member 502, and can move with respect to the base member 502 to engage with the mount-side engagement member 406 of the lens mount 402 of the shooting device 400. The operation member 520 can rotate the rotation body 513 with respect to the base member 502 by sliding with respect to the base member 502.

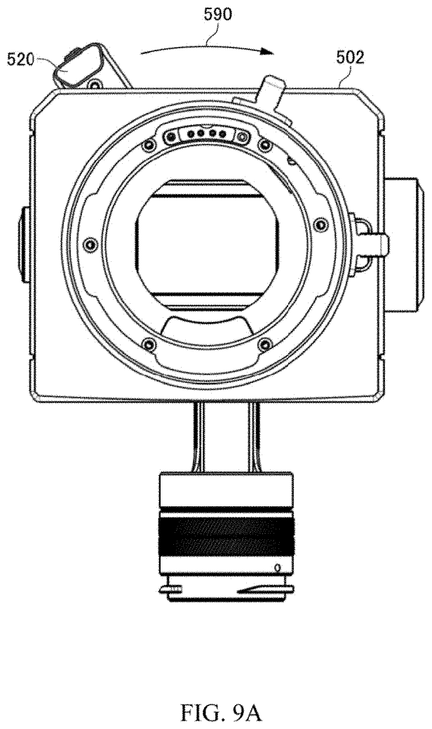

FIG. 9A is a schematic diagram of the mount adapter 500 and the shooting device 400 in an unlocked state consistent with the disclosure. FIG. 9B is a schematic diagram of the mount adapter 500 and the shooting device 400 in a locked state consistent with the disclosure. In the unlocked state where the connection member 510 of the mount adapter 500 is pressed to the mount surface of the lens mount 402 of the shooting device 400, as shown in FIG. 9A, when the operation member 520 slides with respect to the base member 502 in a first direction 590, the rotation body 513 can rotate in the first direction 590, such that the adapter-side engagement member 512 can be engaged with the mount-side engagement member 406 of the lens mount 402 of the shooting device 400. In the locked state where the connection member 510 of the mount adapter 500 is mounted to the mount surface of the lens mount 402 of the shooting device 400, as shown in FIG. 9B, when the operation member 520 slides with respect to the base member 502 in a second direction 592 opposite to the first direction 590, the rotation body 513 can rotate in the second direction 592, such that an engagement of the adapter-side engagement member 512 and the mount-side engagement member 406 of the lens mount 402 of the shooting device 400 can be released. Thus, the mount adapter 500 can be detached from the shooting device 400.

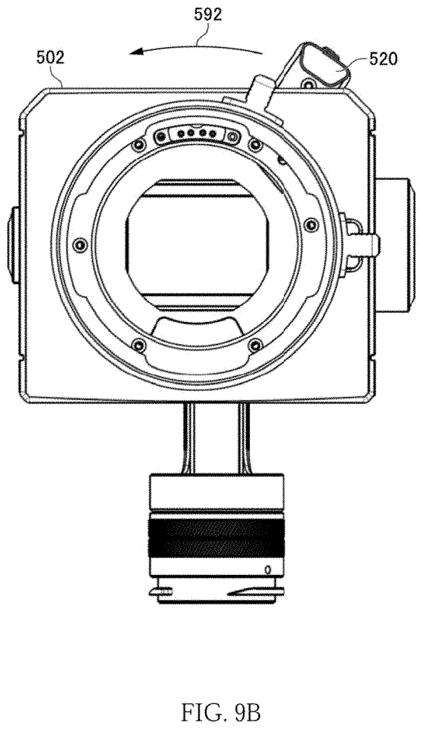

FIG. 10 is a schematic perspective view of the mount adapter 500 with some components being removed consistent with the disclosure. As shown in FIG. 10, the holding member 516 and a cover of the operation member 520 are removed. The operation member 520 includes a lock mechanism 530. The lock mechanism 530 includes a stop member 532 configured to be locked to the holding member 516 to prevent the operation member 520 from moving with respect to the base member 502. The holding member 516 includes a groove on an outer peripheral surface corresponding to a front end portion 533 of one end of the stop member 532, and the front end portion 533 can fit into the groove to prevent the operation member 520 from sliding with respect to the base member 502. The mount adapter 500 further includes a detection member 540 configured to detect whether the stop member 532 is locked to the holding member 516. Herein, the state of the stop member 532 being locked to the holding member 516 can refer to that a portion of the stop member 532 is in contact with a portion of the holding member 516, and the operation member 520 cannot move with respect to the base member 502. For example, the front end portion 533 of the stop member 532 can abut against an edge of the groove of the holding member 516, and the operation member 520 cannot move with respect to the base member 502. Furthermore, for example, when the mount adapter 500 cannot be detached from the shooting device 400, the operation member 520 can be moved with respect to the base member 502. Moreover, for example, when the contact 514 of the mount adapter 500 and the contact 404 of the shooting device 400 are electrically connected, and a communication can be established via the contact 514 of the mount adapter 500 and the contact 404 of the shooting device 400, the operation member 520 can move with respect to the base member 502.

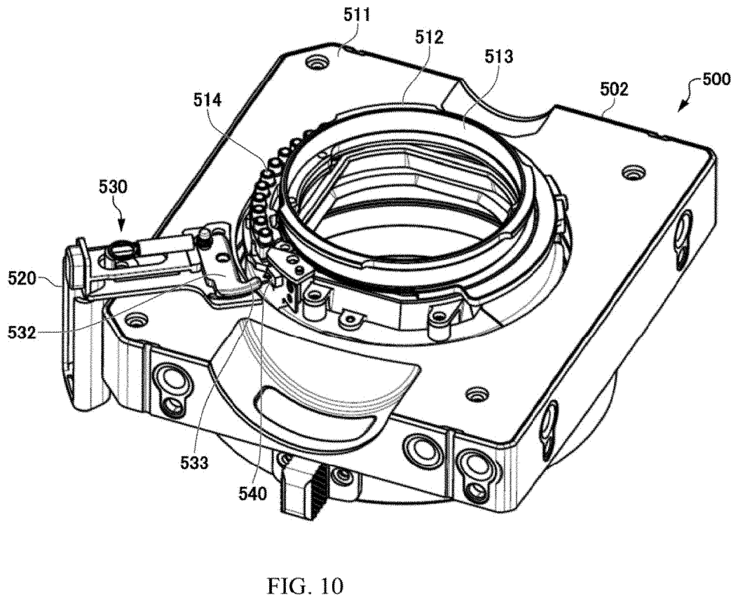

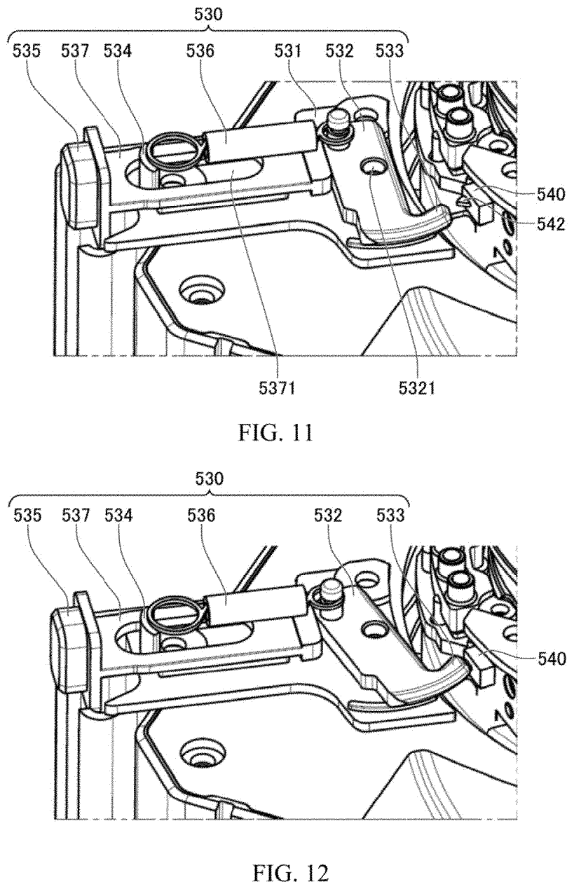

FIGS. 11 and 12 are enlarged perspective views of the lock mechanism 530 consistent with the disclosure. FIG. 11 shows the lock mechanism 530 in a state where a switch 542 of the detection member 540 is not pressed down by the stop member 532. FIG. 12 shows the lock mechanism 530 in a state where the switch 542 of the detection member 540 is pressed down by the stop member 532.

As shown in FIGS. 11 and 12, the lock mechanism 530 further includes a support plate 531, a button 535 and a spring 536. The support plate 531 can movably support the button 535 and the stop member 532. The button 535 is an example of a switch member that can switch between a state where the stop member 532 is locked to the holding member 516 and a state where the stop member 532 is not locked with the holding member 516. The button 535 includes an extension portion 537 extending from a back surface of a pressing surface. The extension portion 537 includes a guide groove 5371. The support plate 531 includes a guide post 534 protruding to one side of the extension portion 537. The guide post 534 can be inserted into the guide groove 5371 to guide the extension portion 537 to move in a longitudinal direction of the guide groove 5371. The stop member 532 includes a through hole 5321 near a center of the stop member 532. The stop member 532 may be rotatably supported at the support plate 531 by a pin protruding from the support plate 531.

When the button 535 is pressed, an end of the extension portion 537 can press the stop member 532. The stop member 532 can be pressed by the extension portion 537 and rotate around the through hole 5321. Therefore, a tip portion 533 of the stop member 532 can move from a state in which the switch 542 of the detection member 540 is pressed by the tip portion 533 to a state in which the switch 542 of the detection member 540 is not pressed by the tip portion 533. When the stop member 532 is locked to the holding member 516, the switch 542 can be pressed by the stop member 532, and the state in which the stop member 532 is locked to the holding member 516 can be detected. When the stop member 532 is not locked by the holding member 516, the switch 542 is not pressed by the stop member 532, and the state where the stop member 532 is not locked by the holding member 516 can be detected.

The spring 536 can be connected to the support plate 531 and the stop member 532. In the state where the button 535 is pressed but the stop member 532 does not press the switch 542, the spring 536 can expand. When the state where the button 535 is pressed is changed to the state where the button 535 is not pressed, the stop member 532 can return to its original position, e.g., the state where the stop member 532 presses the switch 542, by a restoring force of the spring 536.

When the mount adapter 500 is removed from the shooting device 400 during the communication via the contact 514 of the mount adapter 500 and the contact 404 of the shooting device 400, or when the connection between the mount adapter 500 and the shooting device 400 is not complete and the communication is started via the contact 514 of the mount adapter 500 and the contact 404 of the shooting device 400, the communication will be interrupted in the middle of the communication. The interruption of communication may affect a control of the shooting system 10 and the like.

Therefore, in response to the switch 542 being in an off state, the mount adapter 500 can determine that the connection between the mount adapter 500 and the shooting device 400 is incomplete, and the communication via the contact 514 of the mount adapter 500 and the contact 404 of the shooting device 400 cannot be allowed. In response to the switch 542 being in an on state, the mount adapter 500 can determine that the connection between the mount adapter 500 and the shooting device 400 is reliably established, and the communication via the contact 514 of the mount adapter 500 and the contact 404 of the shooting device 400 can be allowed.

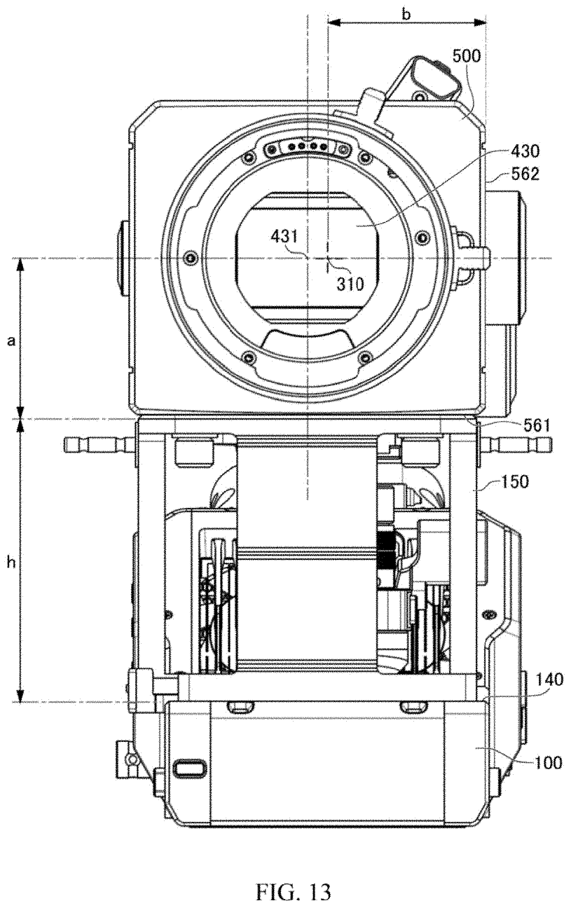

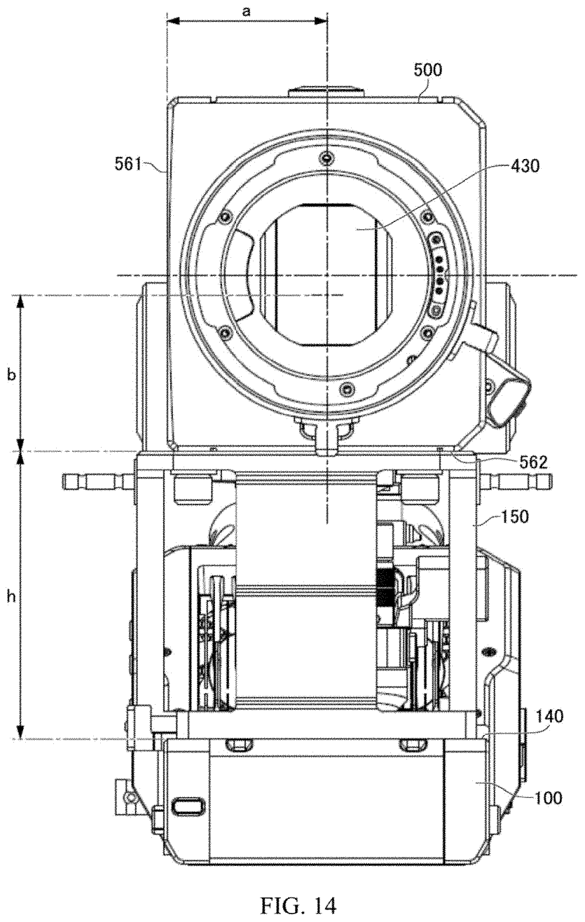

The mount adapter 500 can be fixed to the main body 100 through the support 150. FIG. 13 is a schematic diagram showing the state where the mount adapter 500 is fixed to the main body 100 via the support 150 when the shooting device 400 is in a horizontal shooting attitude consistent with the disclosure. FIG. 14 is a schematic diagram showing the state where the mount adapter 500 is fixed to the main body 100 via the support 150 when the shooting device 400 is in a vertical shooting attitude consistent with the disclosure. As shown in FIG. 13, the mount adaptor 500 can be fixed to the main body 100 via the support 150 when the shooting device 400 is in a first attitude, e.g., the horizontal shooting attitude. As shown in FIG. 14, the mount adaptor 500 can be fixed to the main body 100 via the support 150 when the shooting device 400 is in a second attitude, e.g., the vertical shooting attitude.

The mount adapter 500 can rotate around a yaw axis 310 of the gimbal 300 as a center. The yaw axis 310 may be not coincide with a center 431 of the image sensor 430 in the shooting device 400. Moreover, a height h of the support 150 is constant regardless of whether the shooting device 400 is in the horizontal shooting attitude or the vertical shooting attitude. If a size of the mount adapter 500 is designed under an assumption that the mount adapter 500 rotates around the center 431 of the image sensor 430, a distance between a fixing surface of the mount adapter 500 fixed to the support 150 and the fixing surface 140 of the main body 100 fixed to the support 150 may not be consistent when the shooting device 400 is in the horizontal shooting attitude and the vertical shooting attitude. In this situation, the mount adapter 500 cannot be fixed to the main body 100 through the support 150. Therefore, a shape of the mount adapter 500 can be designed in consideration of a position of the yaw axis 310 of the gimbal 300.

The shape of the mount adapter 500 can be designed to satisfy that a distance between a first fixing surface 561 of the mount adapter 500 mounted to the support 150 and a main-body-side fixing surface 140 of the main body 100 mounted to the support 150, in response to the gimbal 300 supporting the shooting device 400 in the first attitude (e.g., the horizontal shooting attitude), is equal to, a distance between a fixing surface 562 and the main-body-side fixing surface 140, in response to the gimbal 300 supporting the shooting device 400 in the second attitude (e.g., the vertical shooting attitude) after rotating from the first attitude about the yaw axis 310 along the optical axis as the center. For example, the shape of the mount adapter 500 can be designed to satisfy that a distance a between the first fixing surface 561 of the mount adapter 500 fixed to the support 150 and the yaw axis 310, in response to the gimbal 300 supporting the shooting device 400 in the first attitude, is the equal to, a distance b between the second fixing surface 562 of the mount adapter 500 fixed to the support 150 and the yaw axis 310, in response to the gimbal 300 supporting the shooting device 400 in the second attitude. As another example, the shape of the mount adapter 500 can be designed to satisfy that the distance a from the yaw axis 310 to the first fixing surface 561 of the mount adapter 500 for a horizontal shooting is equal to the distance b from the yaw axis 310 to the second fixing surface 562 of the mount adapter 500 for a vertical shooting.

Consistent with the disclosure, through setting the shape of the mount adapter 500 as the shape described above, the mount adapter 500 can be reliably fixed to the main body 100 through the support 150 no matter if the shooting device 400 is in the horizontal shooting attitude or the vertical shooting attitude.

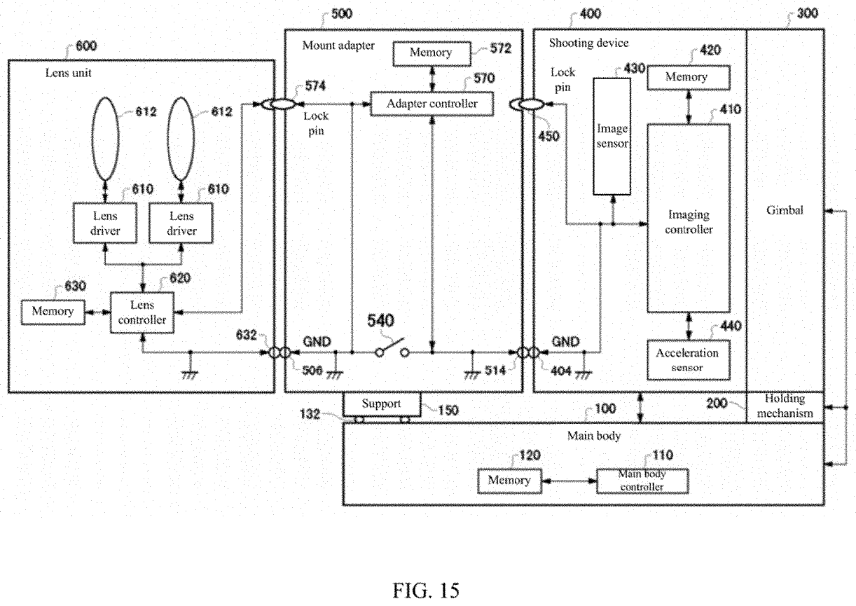

FIG. 15 is a schematic block diagram of the shooting system 10 consistent with the disclosure. As shown in FIG. 15, the shooting system 10 includes the main body 100, the holding mechanism 200, the gimbal 300, the shooting device 400, the mount adapter 500, the support 150, and a lens unit 600.

The main body 100 includes a main body controller 110, a memory 120, and the detection sensor 132. The main body controller 110 can control the shooting system 10. The main body controller 110 is an example of a control device. The main body controller 110 may include a microprocessor, e.g., a central processing unit (CPU) or a microprocessing unit (MPU), a microcontroller, e.g., a microcontroller (MCU), or the like. The memory 120 can store programs and the like that are necessary for the main body controller 110 to control the holding mechanism 200, the gimbal 300, the shooting device 400, the mount adapter 500, and the lens unit 600. The memory 120 may include a computer-readable medium, and may include at least one of a static random-access memory (SRAM), a dynamic random-access memory (DRAM), an erasable programmable read-only memory (EPROM), an electrically erasable programmable read-only memory (EEPROM), and a flash memory, e.g., a universal serial bus (USB) memory, and the like. The memory 120 may be arranged inside the main body 100. The memory 120 can be detachable from the main body 100. The detection sensor 132 can detect if the support 150 is mounted to the main body 100.

The shooting device 400 includes the image sensor 430, an imaging controller 410, a memory 420, and an acceleration sensor 440. The image sensor 430 may include a charge-coupled device (CCD) or a complementary metal oxide semiconductor (CMOS). The image sensor 430 can shoot an optical image imaged via the lens unit 600 and output shot image data to the imaging controller 410. The imaging controller 410 may include a microprocessor, e.g., a CPU or an MPU, a microcontroller, e.g., an MCU, or the like. The imaging controller 410 can control the shooting device 400 according to an operation instruction from the main body controller 110. The memory 420 may include a computer-readable medium, and may include at least one of a SRAM, a DRAM, an EPROM, an EEPROM, a flash memory, e.g., a USB memory, and the like. The memory 420 can store programs and the like that are necessary for the imaging controller 410 to control the image sensor 430 and the like. The memory 420 can be arranged inside the housing of the shooting device 400. The memory 420 can be detachable from the housing of the shooting device 400. The acceleration sensor 440 may include a three-axis acceleration sensor for detecting the attitude of the shooting device 400 and an attitude of the image sensor 430.

The lens unit 600 includes a plurality of lenses 612, a plurality of lens drivers 610, a lens controller 620, and a memory 630. The plurality of lenses 612 can function as zoom lenses, variable focal length lenses, and focus lenses. At least some or all of the plurality of lenses 612 can be configured to move along an optical axis. The lens unit 600 may include an interchangeable lens that can be detachably arranged at the shooting device 400. The plurality of lens drivers 610 can drive at least some or all of the plurality of lenses 612 to move along the optical axis via a mechanism member such as a convex wheel ring. Each lens driver 610 may include the actuator. The actuator may include a stepper motor. The lens controller 620 can drive the plurality of lens driving units 610 according to lens control instructions from the shooting device 400, and move one or more of the plurality of lenses 612 along the optical axis direction via the mechanism member. The lens control instructions can include, for example, a zoom control instruction and a focus control instruction.

The mount adapter 500 includes an adapter controller 570, the detection member 540, and a memory 572. The mount adapter 500 can be detachably mounted to the shooting device 400 via a lock pin 450. The mount adapter 500 can be detachably mounted to the lens unit 600 via a lock pin 574. The mount adapter 500 includes the contact 514 for communicating with the shooting device 400. The shooting device 400 includes the contact 404 for communicating with the mount adapter 500. The mount adapter 500 includes the contact 506 for communicating with the lens unit 600. The lens unit 600 includes a contact 632 for communicating with the mount adapter 500.

The detection member 540 can be configured to detect whether or not the stop member 532 is locked to the holding member 516. That is, the detection member 540 can be configured to detect whether the mount adapter 500 is fixed to the shooting device 400 or not fixed to the shooting device 400. The detection member 540 may include a switch that can physically cut off an electrical connection between the contact 506 and the contact 514.

The adapter controller 570 can be configured to allow a communication via the contact 514 of the mount adapter 500 and the contact 404 of the shooting device 400 when the detection member 540 detects that the stop member 532 is locked to the holding member 516, and not allow the communication via the contact 514 of the mount adapter 500 and the contact 404 of the shooting device 400 when the detection member 540 detects that the stop member 532 is not locked to the holding member 516. Therefore, when the mount adapter 500 is removed from the shooting device 400 during the communication via the contact 514 of the mount adapter 500 and the contact 404 of the shooting device 400, or when the connection between the mount adapter 500 and the shooting device 400 is not complete and the communication is started via the contact 514 of the mount adapter 500 and the contact 404 of the shooting device 400, an effect of the interruption of communication on the control of the shooting system 10 can be avoid. The adapter controller 570 is an example of a communication controller.

The adapter controller 570 can receive a first control signal conforming to a first communication standard from the imaging controller 410 that can control the image sensor 430, convert the first control signal into a second control signal conforming to a second communication standard, and send the second control signal to the lens unit 600. The adapter controller 580 is an example of a conversion circuit. Even if the communication standard of the shooting device 400 and the communication standard of the lens unit 600 are different, the adapter controller 570 can convert the control signal according to the communication standards to allow the shooting device 400 and the lens unit 600 to communicate with each other.

The adapter controller 570 may include a microprocessor, e.g., a CPU or an MPU, a microcontroller, e.g., an MCU, or the like. The memory 520 can store programs and the like that are necessary for controlling the adapter controller 570. The memory 520 may include a computer-readable medium, and may include at least one of a SRAM, a DRAM, an EPROM, an EEPROM, and a flash memory, e.g., a USB memory, and the like. The memory 520 may be arranged inside the mount adapter 500. The memory 520 can be detachable from the mount adapter 500.

As long as the terms “before,” “previous to,” or the like, are not specifically stated, and an output of a previous processing is not used in a subsequent processing, the actions, sequences, steps and stages in the device, system, program and method shown in the claims, description and drawings can be implemented in any order. For the convenience of description, “first,” “next,” and the like are used to describe the operation procedures in the claims, specification and drawings, which do not mean that the operation procedures must be implemented in this order.

It is intended that the disclosed embodiments be considered as exemplary only and not to limit the scope of the disclosure. Changes, modifications, alterations, and variations of the above-described embodiments may be made by those skilled in the art within the scope of the disclosure.

Description of Reference Numerals

| | | | |
|---|---|---|---|
| 10 | Shooting system | 100 | Main body |
| 110 | Main body controller | 120 | Memory |
| 132 | Detection sensor | 140 | Fixing surface |
| 150 | Support | 151 | Mark |
| 152 | Bolt | 200 | Holding mechanism |
| 202 | Holding member | 204 | Rotation member |
| 300 | Gimbal | 301, 303, 305 | Rotation member |
| 302, 304 | Support member | 310 | Yaw axis |
| 400 | Shooting device | 401 | Opening |
| 402 | Lens mount | 404 | Contact |
| 406 | Mount-side | 410 | Imaging |
| | engagement member | | controller |
| 420 | Memory | 430 | Image sensor |
| 440 | Acceleration sensor | 450 | Lock pin |
| 500 | Mount adapter | 501 | Opening |
| 502 | Base member | 504 | Connection member |
| 505 | Adaptor-side | 506 | Contact |
| | engagement member | | |
| 450 | Lock pin | 500 | Mount adapter |
| 510 | Connection | 512 | Adaptor-side |
| | member | | engagement member |
| 513 | Rotation body | 514 | Contact |
| 516 | Holding member | 520 | Operation member |
| 530 | Lock mechanism | 531 | Support plate |
| 532 | Stop member | 533 | Tip portion |
| 534 | Guide post | 535 | Button |
| 537 | Extension portion | 540 | Detection member |
| 542 | Switch | 550 | Concave portion |
| 561 | Fixing surface | 562 | Fixing surface |
| 570 | Adapter controller | 572 | Memory |
| 574 | Lock pin | 600 | Lens unit |
| 610 | Lens driver | 612 | Lens |
| 620 | Lens controller | 630 | Memory |
| 632 | Contact | | |

What is claimed is:

1. A mount adaptor comprising:
a base member;
a first connection member arranged at a first surface of the base member and configured to be detachably connected to a lens unit;
a second connection member arranged at a second surface of the base member and configured to be detachably connected to a shooting device; and
an operation member configured to be operated to mount the second connection member to or detach the second connection member from the shooting device;
wherein the second connection member includes an adapter-side engagement member configured to move in conjunction with the operation member with respect to the base member, to engage with a mount-side engagement member of a lens mount.

2. The mount adaptor of claim 1, wherein the second connection member includes a rotation body connected to the operation member and the adapter-side engagement member, the rotation body being configured to move in conjunction with the operation member with respect to the base member, so as to rotate with respect to the base member together with the adapter-side engagement member.

3. The mount adaptor of claim 2, further comprising:
a contact configured to be electrically connected to a contact of the shooting device.

4. The mount adaptor of claim 3, further comprising:
a holding member configured to hold the contact of the mount adapter electrically connected to the contact of the shooting device and rotatably hold the rotation body with respect to the base member.

5. The mount adaptor of claim 4, wherein the operation member includes a lock mechanism including a stop member configured to be locked to the holding member to prevent the operation member from moving with respect to the base member.

6. The mount adaptor of claim 5, wherein the lock mechanism further includes a switch member configured to switch between a state where the stop member is locked to the holding member and a state where the stop member is not locked to the holding member.

7. The mount adaptor of claim 6, further comprising:
a detection member configured to detect whether the stop member is locked to the holding member.

8. The mount adaptor of claim 7, further comprising:
a communication controller configured to allow a communication via the contact of the mount adapter and the contact of the shooting device, in response to the detection member detecting that the stop member is locked to the holding member.

9. The mount adaptor of claim 7, further comprising:
a communication controller configured to prohibit a communication via the contact of the mount adapter and the contact of the shooting device, in response to the detection member detecting that the stop member is not locked to the holding member.

10. The mount adaptor of claim 7, wherein the detection member includes a switch configured to be pressed by the stop member when the stop member is locked to the holding member, such that the detection member detects whether the stop member is locked to the holding member.

11. The mount adaptor of claim 1, wherein:
the adapter-side engagement member is a first adapter-side engagement member; and
the first connection member includes a second adapter-side engagement member configured to engage with a lens-side engagement member of the lens unit.

12. A shooting system comprising:
a shooting device including an image sensor;
a support mechanism configured to rotatably support the shooting device; and
a mount adaptor including:
a base member;
a first connection member arranged at a first surface of the base member and configured to be detachably connected to a lens unit;
a second connection member arranged at a second surface of the base member and configured to be detachably connected to the shooting device; and
an operation member configured to be operated to mount the second connection member to or detach the second connection member from the shooting device;
wherein the second connection member includes an adapter-side engagement member configured to move in conjunction with the operation member with respect to the base member, to engage with a mount-side engagement member of a lens mount.

13. The system of claim 12, further comprising:
a main body configured to hold the support mechanism; and
a support configured to support the shooting device to maintain a position of the shooting device with respect to the main body.

14. The system of claim 13, wherein the support fixed is to the main body and the mount adaptor.

15. The system of claim 14, wherein:
the support mechanism is configured to support the shooting device in:
a first attitude, and
a second attitude after the shooting device rotates around an optical axis from the first attitude;
a distance between a first fixing surface of the mount adapter mounted to the support and the optical axis, when the support mechanism supports the shooting device in the first attitude, is a first distance;
a distance between a second fixing surface of the mount adapter mounted to the support and the optical axis, when the support mechanism supports the shooting device in the second attitude, is a second distance; and
the first distance equals the second distance.

16. The system of claim 12, wherein the second connection member includes a rotation body connected to the operation member and the adapter-side engagement member, the rotation body being configured to move in conjunction with the operation member with respect to the base member, so as to rotate with respect to the base member together with the adapter-side engagement member.

17. The system of claim 16, wherein the mount adaptor further includes a contact configured to be electrically connected to a contact of the shooting device.

18. The system of claim 17, wherein the mount adaptor further includes a holding member configured to hold the contact of the mount adapter electrically connected to the contact of the shooting device and rotatably hold the rotation body with respect to the base member.

19. The system of claim 18, wherein the operation member includes a lock mechanism including a stop member configured to be locked to the holding member to prevent the operation member from moving with respect to the base member.

20. The system of claim 19, wherein the lock mechanism further includes a switch member configured to switch between a state where the stop member is locked to the holding member and a state where the stop member is not locked to the holding member.
